(19) United States
(12) Patent Application Publication
(10) Pub. No.: US 2015/0011305 A1
(43) Pub. Date: Jan. 8, 2015

(54) CHARITABLE GIVING THROUGH COMPETITIVE ONLINE GAMING

(71) Applicant: OutGive, L3C, Geneva, IL (US)

(72) Inventor: Dana Deardorff, Geneva, IL (US)

(21) Appl. No.: 14/319,478

(22) Filed: Jun. 30, 2014

Related U.S. Application Data
(60) Provisional application No. 61/842,787, filed on Jul. 3, 2013.

(51) Int. Cl. G07F 17/32

(52) U.S. Cl. CPC G07F 17/3258
USPC 463/26

(57) ABSTRACT

Systems, methods, and software are disclosed herein for charitable gaming. Users can play a game and donate money or value to non-profit charitable organizations through online gaming, where the players in a game compete to determine how portions of the value from the game's prize pool will be allocated to one or more charity organizations.

### CROSS REFERENCE TO RELATED APPLICATIONS

This application claims priority to, and benefit from, provisional patent application Ser. No. 61/842,787, entitled “Charitable Giving Through Competitive Online Gaming”, filed Jul. 3, 2013, which is incorporated by reference for all purposes.

### BACKGROUND

The disclosed invention relates to the general field of charitable giving and fundraising through means of games or game-related events and activities. Non-profit charitable organizations, or those interested in raising money on their behalf, have often used various types of special events and entertainment to generate interest in donating money to support their causes. Although such events and entertainment can take many forms, a common approach is the use of games or game-related activities, especially charity gambling or betting. In one such case, participants attend an event and pay money to play casino games such as poker, blackjack, roulette, bingo, etc. Some portion of the total money raised from the games is then given to charity.

However, a major limitation of this approach is that these game activities are legally still gambling—financial rewards are won by the players in the form of cash or other prizes, reducing the total amount given to charity. Another limitation of this approach is that a percentage of the total money raised is paid to the operators and vendors of the games, further reducing the total amount that can be given to charity. Another limitation is that the event is typically hosted for one specific non-profit organization, and the money that is donated is given only to that organization, without any other choices by the participants. Finally, an obvious limitation is that the scope of the event and the money raised may be limited by the number of people that are able to physically attend the event at a specific time to participate in the games.

### OVERVIEW

With the recent development of the internet and related technology, there is a new opportunity to reach a much broader scope of participants for charitable giving through online gaming—both in terms of the number of people as well as the geographic scope. Large numbers of participants could play remotely from virtually anywhere in the world with internet access. Furthermore, the game activities do not need to be limited to a single event at a specific place and time, but could be significantly increased to provide more frequent events or even continuous activities accessible to the players. However, while gaming activities for charitable donations as described previously using casino games or betting can be transformed in scope with the utilization of online hosting, the other limitations still exist. These game activities would still be gambling, have a limited percentage of money given to charity due to amounts paid to winners and to cover operational costs, and wouldn't provide participants with a choice of charity organizations to give the donations.

With the technology platform of the internet, there have been some innovations in the model of using games for charitable and social purposes. These new online charity gaming models generally fall into one of two categories: 1) social games that give a portion of game fees or in-game purchases paid by players to charity, and 2) game sites which are free to play, but give a portion of money to charity from corporate sponsorships or advertising revenue generated.

A limitation of the first category may be that the social games are defined by a style of interactive play that is generally collaborative or cooperative among players, without competitive play to reach a winner or rank order of finishing. A limitation of the second category is that while there is a low barrier to play because the games are free, this typically results in a low level of engagement and interest by the players. Also, these game sites in the second category are commonly not interactive with other players, but are played individually or against a computer. A limitation of both game model categories is that typically the money is donated to a single charitable organization, and the participating players do not get to choose which charity.

The disclosed systems, methods, and software may remove the limitations referenced previously, by providing a novel service model for charitable donations by means of online gaming or other game-related events and activities. The purpose of this system, therefore, is to create a unique way to donate money that is fun and entertaining to engage people to help the charities and causes they want to support.

A primary aim of the invention is to provide charitable giving through online gaming to reach a broad scope of participants to play and donate, as well as a broad scope of game frequency and availability. A further aim of the disclosure is to provide charitable giving through online gaming that is based on competitive play but is not gambling. A further aim of the disclosure is to provide charitable giving through online gaming that is tax-deductible. A further aim of the disclosure is to provide online gaming for charitable donations where the players have options or choices for which organization and the amount of money to give.

A yet further aim of the invention is to provide online gaming for charitable donations where the players can compete for the ability to choose which organizations receive the donations and how much money is donated. A further aim of the invention is to provide online gaming for charitable donations directly from players instead of corporate sponsorships or advertising revenue. A further aim of the invention is to provide a game leaderboard or other incentives based on the amount of donations by players. A further aim of the invention is to create a service model for providing charitable gaming that allows all the money in play to be donated to charities. A final aim of the invention is to create a service model for providing charitable game services that does not require players to pay for the operational expenses of the game hosting.

### SUMMARY

The systems, methods, and software disclosed provides a novel service model for donating money to non-profit charitable organizations through online gaming, where the players in a game compete to determine how the money from the game's prize pool will be allocated to charity. Various types and styles of games or game-related events and activities may be used, provided that there is some form of performance comparison between players, which is then utilized as a basis to select at least one player who will determine the charity donation allocations. In an embodiment of the invention, the game is a poker software platform provided by a host, and players compete online interactively with each other to win money to donate to one or more charity organizations of their choice. Other variations are also possible involving the interactivity of players, the creation and allocation of the prize pool money, the structure of the host provider, and the game software platform.

In a specific embodiment, the game is Texas Hold'em poker, and the players compete against each other interactively online in real-time, by utilizing a game software platform by a host provider. Each player makes a payment of real money or monetary value to buy a corresponding amount of virtual chips or credits, which are deposited into the player's game account. A potential total prize pool of real money is thereby created by the collection of payments from each player. A player may receive a tax deduction receipt for a charitable donation in the amount of the payment, if the host receiving the payment is a registered 501(c) organization. After the game account has been credited, a player is then able to play in regular poker games, such as ring games or “cash” tables (where players can join or leave the table at any time) or structured tournaments (scheduled tournaments with a defined starting time or “sit & go” tournaments that start once a defined number of players are at the table).

Any player who wins chips or credits playing in a game is not eligible to cash-out the game account value as personal winnings, but instead “wins” the opportunity to designate where the money will be donated and the amount of the donation. A player can choose at any time to give the real money value from their game account winnings to one or more non-profit charitable organizations provided through the host software platform. After the player has designated the charity and amount to donate, the value is deducted from the player's game account, and the corresponding real money is distributed from the prize pool to the charitable organization.

### BRIEF DESCRIPTION OF THE DRAWINGS

FIG. 1 illustrates a charitable gaming system environment according to an example.

FIG. 2 illustrates method of operation of a charitable gaming system according to an example.

FIG. 3 illustrates a charitable system according to an example.

### DESCRIPTION

An embodiment of using poker for the game activity is based on several factors, such as its popularity (in the U.S. as well as throughout the world), a combination of elements for both skill and chance, and competitive play leading to defined winners and rank of players. There are many variations and styles of poker (such as stud, draw, different betting limits, etc.), and any of them could be used suitably for this system without limitation.

However, many other games could be used effectively instead of poker, regardless of the popularity or amount of skill and chance involved. By way of example and without limitation or restriction, the following types of games could be used: card games (such as bridge, whist, euchre, hearts, spades, pinochle, rummy, canasta, etc.), casino/betting games (such as roulette, craps, blackjack, slots, keno, baccarat, bingo, etc.), pure skill games (such as chess, checkers, othello, go), action games, video/arcade games, word games, sports games, board games, and dice games. In fact, any type of game or game activity could be suitable, provided that there is at least one metric used to compare performance between or among players or teams competitively, such as points, score, chips, credit, money, wins, rank, position, etc. Multiple games could also be utilized, and players could be allowed to select one or more they would like to play.

In an embodiment using the game of poker, the players compete against each other interactively in real-time using an internet network connection. However, depending on the type and nature of the game, other forms of competitive interactive play may be utilized. For example, instead of competing in real-time, players may compete against each other at different times (i.e. not playing the game at the same time), and then have their performances compared at a separate time. In another embodiment, players may compete against a computer instead of directly against other players, and then have their performances compared. Games could be scheduled to start at a specific time, or other games could be played at any time that players choose. Players could also compete together as a team, instead of an individual performance. Players could also compete in multiple games repetitively or in a tournament format. The nature of the interaction of players could take many different forms, provided that there is at least one common metric to compare performance between or among players or teams.

In another embodiment, the players do not compete directly by playing in a game, but instead try to predict the outcome of a separate sporting game or event. In this embodiment, players pay money into a prize pool, and make a selection for the outcome of the game or event before it has ended (for example, picking the winner), using the online software platform provided by the host. After the game or event has been completed, the corresponding value of the prize pool is distributed to the players who made the correct predictions. Similar to other embodiments, any player who wins money is not eligible to cash-out their account value as personal winnings, but instead “wins” the opportunity to select where this money will be donated. This embodiment is suitable to many types of sporting events, tournaments, or games played by professionals or amateurs, which are commonly used for sports betting. By way of example and without limitation or restriction, the following sports and sporting activities could be used: basketball, soccer, football, rugby, cricket, baseball, hockey, golf, tennis, boxing/fighting, wrestling, volleyball, track and field, car racing, horse racing, and dog racing.

In an embodiment, the prize pool of money is created by players making payment directly online to play in the games. This payment into the prize pool can be accomplished by various means, such as a credit or debit card, redeemable or transferable gift card, electronic bank transfer, transfer from another online account, wire transfer, bitcoins, promissory note, digital value, online payment service such as PayPal, cash, check, and/or payment of other monetary or other value. While this method does require players to pay for their own game account, it potentially results in a greater level of player interest and engagement in the games and outcomes. However, other approaches may also be utilized to create the prize pool.

The prize pool may also be created entirely or partially by other individuals, companies, or organizations interested in donating to the charities through the game platform. Similarly, the prize pool may be created by other individuals, companies, or organizations interested in advertising through the game platform. Also, the prize pool may be real or virtual (represented by other game credits, chips, points, scores, etc. in a player's game account) and can be created or transferred before, during, or after the game is played. In an embodiment, the prize pool is created using real money before the players start a game (e.g. as players buy-in to play), and the relative values between players may be changing during games as different players win or lose credits in the games. In an alternative embodiment, players may pay into the prize pool or transfer money to other players after the game is over, based on their relative performance comparison in the game. For example, a player would only pay into the prize pool if the player loses a game, or a winner would pay less into the prize pool than a loser.

There are also various approaches that can be used to determine how the money from the prize pool that is donated to the charities will be allocated. In an embodiment, players have the opportunity to designate both the charity organization and amount they would like to donate from their winnings after playing a game. The process of designating the charity recipients and donation amounts may be independent of the game, or may be related to the performance comparison of players in the game. In an alternative embodiment, the amount that a player can donate is selected before playing the game, or predetermined by the eventual finishing position or rank of the players in the game (for example, 1^{st} place can designate the donation for 70% of the prize pool and 2^{nd} place can donate 30% of the prize pool). Similarly, the charity organization may be selected before playing the game, or predetermined by the finishing position or rank of the players in the game. Players may also be given the ability to customize charity options for fundraising purposes (for example, a player could create a game or tournament where all winnings would go to a specific charity).

Donations can be allocated be a sole winner or player in a game or by multiple players. Designation of which charity organization to donate the money can be made from a predefined list of potential options, which is accessed by the players through the host software platform. Designation of the charity organization could also be made to any registered non-profit organization, as provided in a database such as GuideStar. The donations from the prize pool may be distributed to the charity organizations individually and immediately as they are designated by the players, or accumulated and distributed collectively at a regular time period (such as weekly or monthly). The donation distributions of the prize pool money to the charities may be delivered via check, digital payment, electronic bank transfer, wire transfer, or any other means of donation accepted by the receiving charity organization. In an alternative embodiment, the money from the prize pool could be given to an organization that is not registered as a 501(c) non-profit or directly to an individual person (though this approach has limitations for tax deductibility).

In an embodiment, at least part of the payments made by players into the prize pool or to buy-in to a game are tax-deductible donations, because the money is received and receipted by a registered 501(c) non-profit organization. This can be accomplished if the host provider of the software platform is a registered 501(c) organization and receives the payments directly, and then distributes the money to other charities based on the player-designated allocations. Tax-deductibility can also be accomplished if the payments go to a 501(c) organization that is separate from the host provider, such as a donor advised fund (for example, Network for Good, JustGive, or Razoo), which is suited to receive donations online and then re-distribute the money to charities based on the player designations.

The benefit of this approach is that the host organization could be a for-profit company (or low-profit company such as a L3C or B corporation) and not be responsible for the financial transaction process, but the game payments would still be tax-deductible. In one embodiment, all of the payments made by players into the prize pool are completely tax deductible, and all of the prize pool money is donated to charity organizations. In an alternative embodiment, the host organization is not a registered 501(c) non-profit, but still receives the payments directly (even though these payments may not be tax-deductible).

Regardless of the corporate structure of the host organization or person, there are several ways that the host provider can generate revenue to support the operation of the software platform and other operational expenses. In one embodiment, players pay a separate service fee directly to the host provider, which is a fixed amount or percentage of their payment to buy-in to a game. In another embodiment, a fixed amount or percentage is deducted from each game, winning pot, or donation made to a charity, and then paid to the host provider as a service fee. In another embodiment, service fees are collected on an optional basis, allowing players to give a discretionary or variable “tip” amount of their choice to the host provider before, during, or after a game is played. Revenue can also be generated directly through the purchase of premium-level services or products or other in-game sales. Revenue generation can also be achieved indirectly through other partnerships, corporate sponsorships, and advertising within or related to the software platform.

Although in an embodiment poker is played using real money (or virtual credit accounts which represent real money), it is not legally considered gambling because the players are not eligible to “cash-out” or receive any winnings as personal prizes. What the players “win” instead is the ability to designate where the money will be donated and how much will be donated. A leaderboard, player ranking, and status levels can be generated in the game based on how much money a player has designated for donations to charity. In order to maintain that the game status is not gambling, cash prizes or other gifts could still be given to the players, provided that the prizes are not directly resulting from or linked to winning or player performance. For example, prizes could be given to players based on activity levels, random drawings, or referrals. In an alternative embodiment, the players can receive prizes directly related to winning, though this approach may have restrictions or limitations based on the laws pertaining to internet gambling.

The software game platform can be constructed in various configurations to achieve the aims of the invention. In one example, the software platform is a website application that can be accessed universally by multiple types of devices (for example: desktop or laptop computers, tablets, smartphones, etc.) via a browser with an internet connection. In this configuration, the core game software platform would be hosted by a server, with commands and responses sent interactively between the server and client display for each player's device.

In another embodiment, some or all of the game software can be transferred to the player's device in the form of a downloadable program or application. The downloadable program or application could be generic or also specific for use only on a predetermined operating system or device. Regardless of the configuration, the software platform provides the ability to process payments, connect players to play games, and make donations to the designated charities via an internet network.

The preceding examples and variations described above are intended only to give an idea of the potential embodiments of the invention, and are not intended to restrict or limit the scope of the invention. Other variations are also possible. It should also be noted that different combinations of the variations described may be used interchangeably. In fact, in one embodiment, players are given the opportunity through the software platform to change or customize various aspects of the set-up, such as the type of game, the players invited, the structure and amount of the prize pool, the performance metric for competition, or the charity options for donations.

Embodiments disclosed herein may be totally or partially implemented on one or more processing devices such as a computer, smartphone, or any other processing device. Embodiments may include a method, system, and/or apparatus. Embodiments may include an application running on a smartphone as well as a server or other storage device.

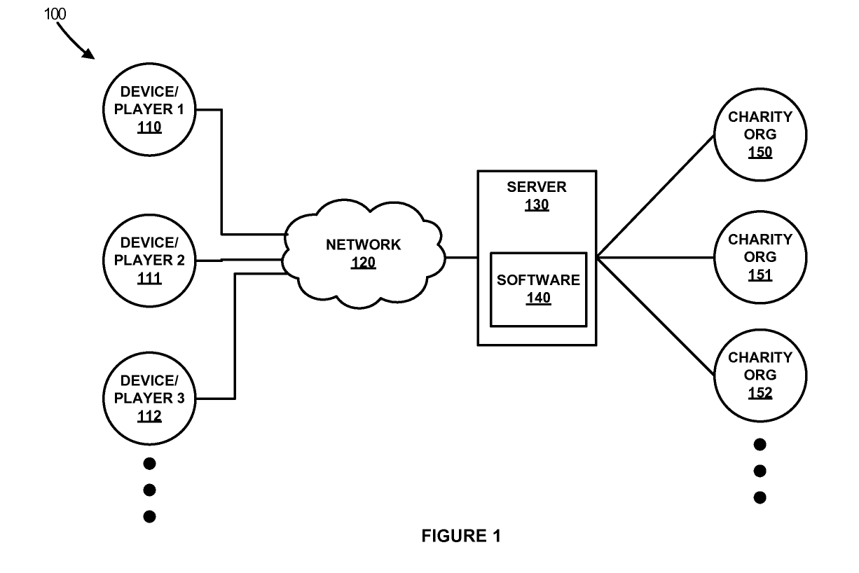

FIG. 1 illustrates a charitable gaming environment 100, according to an example. Environment 100 includes devices/players 1-3, 110 111 112. Devices 110-112 may communicationally couple to server 130 at least in part via network 120. Server 130 can include software 140, which can facilitate charitable gaming. Server 130 may also be coupled to charity organizations 150-152 via a network connection or any other means.

Devices 110-112 may be capable of sending and receiving information from server 130, and interacting with software 140. Software 140 is capable of implementing some or all of the functionality described herein. Although 3 devices 110-112 are shown, many devices may be coupled or connected to server 130 via network 120. Users or players may access server 130 and software 140 and enter login information. The users/players may then purchase credits, coins, chips, digital value, or other game account value to use in gaming on server 130.

Users may then use devices 110-112 to access software 140 to play one or more games, such as poker using the value of virtual poker chips purchased. The users may then play a game, such as a poker tournament using the chips to wager. A winning user may then designate one or more charity organizations 150-152 to donate a portion or all of the value of the chips won. The user can also choose to instruct the server 130 to donate the value of chips purchased or won to one or more charity organizations 150-152, even if they have not won the tournament or game.

Donations can be made be a sole winner or player in a game or by multiple players. Selection of which charity organization 150-152 to donate the money can be made from a predefined list of potential options, which is accessed by the players through the host software platform 140. Selection of the charity organization 150-152 could also be made to any registered non-profit organization, as provided in a database such as GuideStar. In an alternative embodiment, the money from the prize pool could be given to an organization that is not registered as a 501(c) non-profit or directly to an individual person (though this approach has limitations for tax deductibility).

In an embodiment, the payments made by players into a prize pool or to buy-in to a game are tax-deductible donations, because the money is received and receipted by a registered 501(c) non-profit organization. This can be accomplished if the host provider of the software platform is a registered 501(c) organization and receives the payments directly, and then distributes the money to other charities 150-152 based on the player-designated allocations. Tax-deductibility can also be accomplished if the payments go to a 501(c) organization that is separate from the host provider, such as a donor advised fund (for example, Network for Good, JustGive, or Razoo), which is suited to receive donations online and then re-distribute the money to charities based on the player designations.

Although one server and one software module is shown, the hardware, software, and/or firmware capabilities may be more than one, and distributed over various computing devices, including other servers, and devices 110-112.

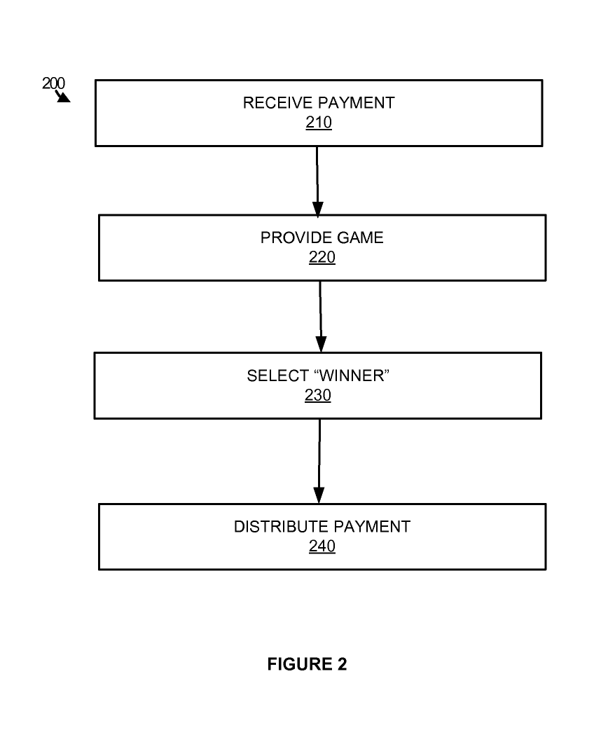

FIG. 2 illustrates a charitable gaming method 200, according to an example. The method begins with receiving a payment at a server (210) from two or more players. The payment can be made using a credit card (or other suitable means as described previously) to purchase game account value or credits. The payments provided by the two or more players may be used to create a “prize pool” which will be donated to one or more charity organizations.

After the game accounts of the players have been credited, the game may be provided by the host server (220). The game provided can include one or more criteria or defined metrics to compare the performance of two or more users playing the game. For example, the defined metrics could include the rules and rank of winning hands in poker, the winner of a slot machine tournament, the position of a race, other combinations of metrics, etc.

After the game is over, one or more “winners” of the game may be selected (230) using the performance comparison. The winners of the game may receive game account value or credits from other players in the game. Although the game account values represent real money in the prize pool, the winners cannot cash out or receive the game credits as personal winnings. Instead, the winners may designate one or more charitable organizations and an amount of value to be donated to the charities from the prize pool. The donation amount may be a portion or all of the value or credits the winner may have in their game account. The winner may use any portion not allocated as a donation to play another tournament or game.

Donations to the charities may then be distributed by the system (240) from the prize pool money. The charities may be preauthorized, or may be designated by the winner. The system may cause the selected amounts to be donated immediately to the designated charitable organizations, or distributed at some later time.

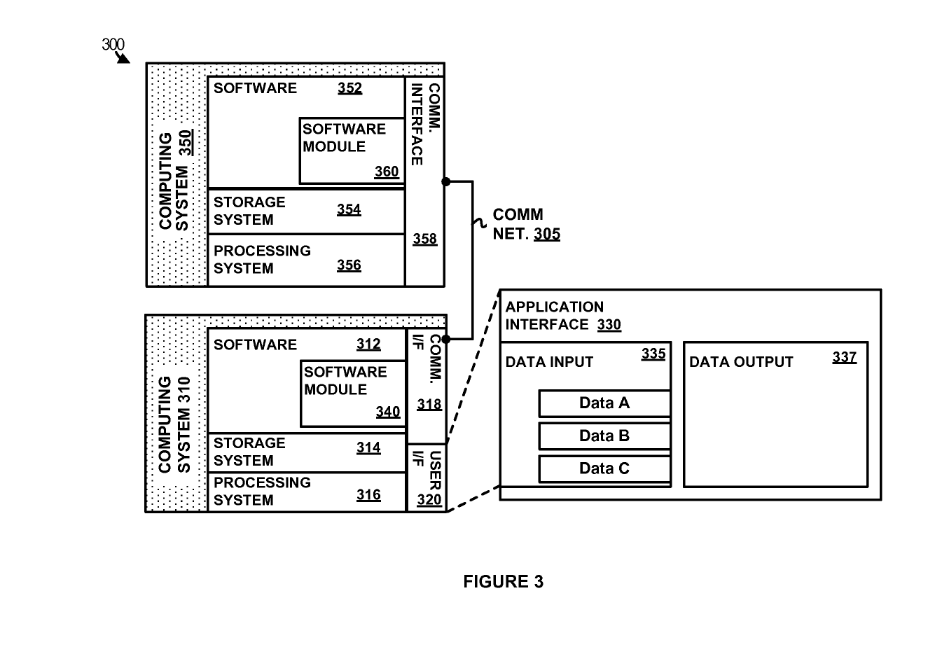

FIG. 3 illustrates a monitoring computing environment 300 according to one example. In an example, computing environment 300 includes computing system 310 and computing system 350. Computing system 310, in the present example, corresponds to user device 110-112, and computing system 350 corresponds to server 130.

Computing system 310 can include any smart phone, tablet computer, laptop computer, computing device, or other device capable of reading, and/or recording data about systems, devices, locations, and/or equipment, etc. Computing system 350 can include any server computer, desktop computer, laptop computer, computing device, or other device capable of sending and receiving information to and from computing system 310 or other similar computing systems, and implementing some or all of the functionality of a charitable gaming system as described herein.

In FIG. 3, computing system 310 includes processing system 316, storage system 314, software 312, communication interface 318, and user interface 320. Processing system 316 loads and executes software 312 from storage system 314, including software module 340. When executed by computing system 310, software module 340 directs processing system 316 to carry out the methods and functionality described herein. Although computing system 310 is shown as including one software module in the present example, it should be understood that one or more modules could provide the same operation. Furthermore, more than one computing system may be used to implement the system and functionality described herein.

Software 312 and/or software module 340 may include software modules such as a payment module configured to receive payment from two or more users, an accounting module configured to create a prize pool of money comprising at least part of the payments received from the two or more users, a game module configured to provide a game to be played online by two or more players, a comparison module configured to compare the relative performance of the two or more players using at least one defined metric, a selection module configured to select one or more of the players based at least in part on the result of the performance comparison, and an allocation module configured to allocate an amount of the prize pool money to be donated to one or more recipient charity organizations based at least in part on a designation from the one or more selected players. It will be appreciated that other modules may also be included for causing other aspects of this disclosure to be carried out by the server.

Additionally, computing system 310 includes communication interface 318 that can be further configured to transmit the collected data to computing system 350 using communication network 305. Communication network 305 could include the Internet, cellular network, satellite network, RF communication, blue-tooth type communication or any other form of wired or wireless communication network capable of facilitating communication between computing systems 310, 350.

Referring still to FIG. 3, processing system 316 can comprise a microprocessor and other circuitry that retrieves and executes software 312 from storage system 314. Processing system 316 can be implemented within a single processing device but can also be distributed across multiple processing devices or sub-systems that cooperate in executing program instructions. Examples of processing system 316 include general purpose central processing units, application specific processors, and logic devices, as well as any other type of processing device, combinations of processing devices, or variations thereof.

Storage system 314 can comprise any storage media readable by processing system 316, and capable of storing software 312. Storage system 314 can include volatile and nonvolatile, removable and non-removable media implemented in any method or technology for storage of information, such as computer readable instructions, data structures, program modules, or other data. Storage system 314 can be implemented as a single storage device but may also be implemented across multiple storage devices or sub-systems. Storage system 314 can comprise additional elements, such as a controller, capable of communicating with processing system 316.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

User interface 320 can include a mouse, a keyboard, a camera, a voice input device, a touch input device for receiving a gesture from a user, a motion input device for detecting non-touch gestures and other motions by a user, and other comparable input devices and associated processing elements capable of receiving user input from a user. These input devices can be used for defining data about the systems, devices, locations, and/or equipment, etc. Output devices such as a graphical display, speakers, printer, haptic devices, and other types of output devices may also be included in user interface 320.

User interface 330 can include data input 335 and data output 337. In one example, data input 335 and data output can be used to implement various aspects of the charitable gaming system described herein. The data inputted and outputted may include information to achieve charitable gaming as described herein.

Computing system 350 includes processing system 356, storage system 354, software 352, and communication interface 358. Processing system 356 loads and executes software 352 from storage system 354, including software module 360. When executed by computing system 350, software module 360 directs processing system 310 to store and manage the data from computing system 310 and other similar computing systems to achieve a charitable gaming system.

Although computing system 310 includes one software module in the present example, it should be understood that one or more modules could provide the same operation. Additionally, computing system 350 includes communication interface 358 that can be configured to receive the data from computing system 310 using communication network 305. Furthermore, communication interface 318, 358 is capable of sending and receiving information to and from sensors capable of transmitting and receiving information at least in part via a wired or wireless communication.

Referring still to FIG. 3, processing system 356 can comprise a microprocessor and other circuitry that retrieves and executes software 352 from storage system 354. Processing system 356 can be implemented within a single processing device but can also be distributed across multiple processing devices or sub-systems that cooperate in executing program instructions. Examples of processing system 356 include general purpose central processing units, application specific processors, and logic devices, as well as any other type of processing device, combinations of processing devices, or variations thereof.

Storage system 354 can comprise any storage media readable by processing system 356 and capable of storing software 352 and data from computing system 310. Storage system 354 can include volatile and nonvolatile, removable and non-removable media implemented in any method or technology for storage of information, such as computer readable instructions, data structures, program modules, or other data. Storage system 354 can be implemented as a single storage device but may also be implemented across multiple storage devices or sub-systems. Storage system 354 can comprise additional elements, such as a controller, capable of communicating with processing system 356.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

In some examples, computing system 350 could include a user interface. The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in the user interface. The aforementioned user input and output devices are well known in the art and need not be discussed at length here.

In some examples, system 350 may not include a user interface. It should be understood that although computing system 350 is shown as one system, the system can comprise one or more systems to store and manage received data.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method of charitable gaming, comprising:
receiving a payment at a server from two or more players;
creating a prize pool of money based at least in part on the payments received from the two or more players;
providing a game configured by the server to be played online by two or more players;
comparing the relative performance of the two or more players using at least one defined metric;
selecting one or more of the players based at least in part on the result of the performance comparison; and
determining at least one of an amount of the prize pool money to be donated and one or more recipient charity organizations, based at least in part on a designation from the one or more selected players.

2. The method of claim 1, further comprising distributing the donation from the prize pool money to the one or more recipient charity organizations based at least in part on the determined amount from a player designation.

3. The method of claim 1, further comprising sending a charitable donation tax receipt to the two or more players for at least part of the amount of the payment received.

4. The method of claim 1, wherein the payment comprises at least one of cash, check, digital value, digital payment service, credit card, debit card, gift card, promissory note, or other monetary value.

5. The method of claim 1, further comprising:
crediting a game account for each of the two or more players corresponding to the amount of each payment received;
transferring game account value to the one or more selected players from one or more other players based at least in part on the result of the performance comparison of the game;
and deducting a value from the game account of the one or more selected players based at least in part on the determined amount of the donation.

6. The method of claim 1, wherein the game comprises Texas Hold'em poker, and the performance comparison metrics comprise the rules of Texas Hold'em poker and the ranking of hands.

7. The method of claim 1, further comprising receiving a separate payment from at least one of the two or more players.

8. The method of claim 1, further comprising creating a game leaderboard ranking the two or more players based at least in part on the determined amount of the prize pool money donation designated by the one or more selected players.

9. The method of claim 1, wherein the two or more players play the game interactively, generally in real-time.

10. The method of claim 1, wherein the server is included in a cloud-based application.

11. A non-volatile computer readable medium comprising instructions enabling individuals to donate money to non-profit charitable organizations, which if executed by a processor, cause the processor to:
create an account containing payment from two or more players;
provide a game that can be played online by two or more players associated with the account;
compare the relative performance of the players using at least one defined metric;
select one or more players based at least in part on the result of the performance comparison; and
allocate a portion of the payments in the account to be donated to one or more charitable organizations based on designation from the one or more selected players.

12. The computer readable medium of claim 11, further comprising instructions which cause the processor to provide a charitable donation tax receipt to the two or more players for at least part of the amount of the payment received.

13. The computer readable medium of claim 11, further comprising instructions wherein the payment comprises at least one of cash, check, digital value, digital payment service, credit card, debit card, gift card, promissory note, or other monetary value.

14. The computer readable medium of claim 11, further comprising instructions wherein the game comprises Texas Hold'em poker, and the performance comparison metrics comprise the rules of Texas Hold'em poker and the ranking of hands.

15. The computer readable medium of claim 11, further comprising instructions which cause the processor to receive a separate payment from at least one of the two or more players.

16. The computer readable medium of claim 11, further comprising instructions which cause the processor to create a game leaderboard ranking the two or more players based at least in part on the allocated donation designated by the one or more selected players

17. A charitable gaming system, comprising:
a server configured to execute software modules stored on a storage device, the software modules comprising:
a payment module configured to receive payment from two or more users;
an accounting module configured to create a prize pool of money comprising at least part of the payments received from the two or more users;
a game module configured to provide a game to be played online by two or more players;
a comparison module configured to compare the relative performance of the two or more players using at least one defined metric;
a selection module configured to select one or more of the players based at least in part on the result of the performance comparison; and
an allocation module configured to allocate an amount of the prize pool money to be donated to one or more recipient charity organizations based at least in part on a designation from the one or more selected players.

18. The system of claim 17, further comprising a distribution module configured to distribute the prize pool money to the one or more recipient charity organization based at least in part on the designated allocation.

19. The system of claim 17, further comprising a receipt module configured to send a charitable donation tax receipt to the two or more players for at least part of the payment received.

20. The system of claim 17, further comprising a donation receiving module configured to receive a separate donation payment from at least one of the two or more players.
